(19) United States
(12) Patent Application Publication
(10) Pub. No.: US 2016/0025018 A1
(43) Pub. Date: Jan. 28, 2016

(54) COMPRESSION RELIEF BRAKE RESET MECHANISM

(71) Applicant: CUMMINS INC., Columbus, IN (US)

(72) Inventors: Richard J. Gustafson, Columbus, IN (US); Bradford L. Lynch, Willowbrook, IL (US)

(21) Appl. No.: 14/776,171

(22) PCT Filed: Mar. 17, 2014
(86) PCT No.: PCT/US14/30335

§ 371 Date: Sep. 14, 2015

Related U.S. Application Data
(60) Provisional application No. 61/800,868, filed on Mar. 15, 2013.

(51) Int. Cl. F02D 13/04

(52) U.S. Cl. CPC F02D 13/04

(57) ABSTRACT

An internal combustion engine with a braking system comprising a rocker lever, a rocker lever valve and a biasing member selectively preventing contact between a brake lift portion of a cam and a cam follower supported by the rocker lever. Fluid pressures in a first fluid circuit and a second fluid circuit selectively actuate the rocker lever valve to open an exhaust valve and cause brake events.

### CROSS-REFERENCE TO RELATED APPLICATIONS

This application claims the benefit of priority from U.S. Provisional Patent Application No. 61/800,868 filed on Mar. 15, 2013 titled “Compression Relief Brake Reset Mechanism,” which is incorporated by reference herein in its entirety.

### FIELD OF THE DISCLOSURE

The disclosure relates to compression braking systems for internal combustion engines.

### BACKGROUND OF THE DISCLOSURE

Compression braking entails switching a combustion engine from a power mode to a braking mode by cutting off fuel flow and opening one or more cylinder exhaust valves near the end of the compression stroke. In one known technique, three-way solenoids are energized to cause pressurized lubricating oil to flow through a control valve, creating a hydraulic link between a master piston and a slave piston. The master piston is displaced inward by an engine element periodically in timed relationship with the compression stroke of the engine which in turn actuates the slave piston through hydraulic force to open the exhaust valves.

In another known technique, the exhaust valves are normally operated during the engine's power mode by an exhaust rocker lever. A reset valve actuates a slave piston during braking. As a result, the exhaust valve is closed prior to the end of the expansion stroke and before the hydraulic pressure drops due to a return motion of the master piston. The reset valve is formed in the rocker lever and is periodically mechanically reset by pivoting action of the rocker lever.

There is a need for an improved engine compression braking system capable of compression braking while utilizing fewer parts to reduce the risk of failure of the system.

### SUMMARY OF DISCLOSED EMBODIMENTS

A compression braking system, an internal combustion engine including the compression braking system, and method of compression braking are disclosed. In some embodiments, the method comprises starting the internal combustion engine, the internal combustion engine including a cylinder, a cam having a brake lift portion, and a pivotally mounted rocker lever supporting a cam follower and a slave piston, the rocker lever including a first fluid circuit, a second fluid circuit and a rocker lever valve along the second fluid circuit. The method further comprises applying a first fluid pressure to the first fluid circuit to open the rocker lever valve; applying a biasing force to the rocker lever to prevent contact between the cam follower and the brake lift portion of the cam; engaging a brake mode, and while in the brake mode: applying a brake mode fluid pressure to a fluid in the second fluid circuit to extend the slave piston to an extended position; and contacting the cam follower with the brake lift portion of the cam to open an exhaust valve in the cylinder of the internal combustion engine and cause a brake event.

In another embodiment, an internal combustion engine operable in a brake mode is disclosed. The internal combustion engine comprises a cylinder and an exhaust valve operable to exhaust combusted gases from the cylinder to cause brake events. The internal combustion engine further comprises a rocker lever pivotally mounted on a rocker lever shaft; a cam including a brake lift portion; a cam follower mounted on the rocker lever; and a slave piston mounted on the rocker lever and connected to the exhaust valve. The internal combustion further comprises a first fluid circuit formed in the rocker lever; a biasing member mounted on a stationary element of the internal combustion engine and applying a biasing force to the rocker lever to pivot the rocker lever and prevent contact between the cam follower and the brake lift portion of the cam, to prevent the brake events; a second fluid circuit formed in the rocker lever and fluidly coupled with the slave piston; and a rocker lever valve along the second fluid circuit. Application of a brake mode fluid pressure to a fluid in the second fluid circuit extends the slave piston to an extended position, which at least partially collapses the biasing member and permits contact between the cam follower and the brake lift portion of the cam, to activate brake events as the cam rotates.

In a further embodiment, a braking system for an internal combustion engine is disclosed. The braking system is operable in an internal combustion engine including a cylinder and an exhaust valve operable to exhaust combusted gases from the cylinder to cause brake events. The braking system comprises a rocker lever pivotally mounted on a rocker lever shaft; a cam including a brake lift portion; a cam follower mounted on the rocker lever; and a slave piston mounted on the rocker lever and connected to the exhaust valve. The braking system further comprises a first fluid circuit formed in the rocker lever; a biasing member mounted to a stationary element of the internal combustion engine and applying a biasing force to the rocker lever to pivot the rocker lever and prevent contact between the cam follower and the brake lift portion of the cam, to prevent the brake events; a second fluid circuit formed in the rocker lever and fluidly coupled with the slave piston; and a rocker lever valve along the second fluid circuit. Application of a brake mode fluid pressure to a fluid in the second fluid circuit extends the slave piston to an extended position, which at least partially collapses the biasing member and permits contact between the cam follower and the brake lift portion of the cam, to activate brake events as the cam rotates.

### BRIEF DESCRIPTION OF THE DRAWINGS

The above-mentioned and other disclosed features, the manner of attaining them, and the advantages thereof will become more apparent and will be better understood by reference to the following description of disclosed embodiments taken in conjunction with the accompanying drawings, wherein:

FIGS. 1 and 2 are cross-sectional views of a prior art braking system set forth in the disclosure;

FIGS. 3 and 4 are cross-sectional views of an embodiment of a compression braking system set forth in the disclosure;

FIG. 5 is a flowchart of an embodiment set forth in the disclosure of a method of braking with an internal combustion engine; and

FIG. 6 is a timing diagram corresponding to the method described with reference to FIG. 5.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE DISCLOSURE

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

A braking system for an internal combustion engine generally comprises a rocker lever having a first fluid circuit, a second fluid circuit fluidly coupled with a slave piston, and a rocker lever valve along the second fluid circuit. The braking system also includes a biasing member applying a biasing force to the rocker lever to pivot the rocker lever and prevent contact between a cam follower and a brake lift portion of a cam, to prevent brake events in the power mode of operation. Application of a brake mode fluid pressure to a fluid in the second fluid circuit extends the slave piston to an extended position, which at least partially collapses the biasing member and permits contact between the cam follower and the brake lift portion of the cam, to activate brake events as the cam rotates in the brake mode of operation. The first fluid circuit is also pressurized. When fluid pressure in the second fluid circuit is reduced, the pressure in the first fluid circuit opens the rocker lever valve, which enables the slave piston to retract from the extended position, which again prevents contact between the cam follower of the brake lift portion of the cam. Exemplary biasing members include leaf springs, torsional springs, compression springs, and any other tensionable resilient member. The biasing member may be connected to a stationary element of the engine. In one example, the biasing member is connected to a rocker lever shaft which pivotally supports the rocker lever.

In some embodiments of the braking system, the rocker lever valve includes a gate, a valve seat, and a return spring applying pressure against the gate opposite the first fluid pressure. In a variation thereof, the spring has a potential energy, when compressed, sufficient to close the rocker lever valve when the first fluid pressure and the brake mode fluid pressure are equal. The first fluid pressure may be an overhead oil pressure of the internal combustion engine or may be another pressure. The overhead oil pressure is convenient because it is readily available throughout the engine. In another variation, the first fluid pressure and the brake mode fluid pressure are different, and a spring is selected which has sufficient potential energy to overcome the difference and close the rocker lever valve but not so high that it closes the rocker lever valve in the power mode, when pressure in the low pressure circuit may be positive and substantially near 0 pounds per square inch (PSI).

In some embodiments, the brake lift section of the cam is contoured proportionally to a predetermined seating velocity of the exhaust valve. Thus, as the cam rotates in the brake mode, contact between the cam follower and the cam pivots the rocker lever and actuates the exhaust valve, and the seating velocity of the exhaust valve is controlled by the cam. The cam can therefore be shaped to achieve a seating velocity which exhausts the combusted gases while also reducing shock and stress, which shock and stress increase wear and the risk of failure of the braking system. Contouring therefore increases the reliability of the braking system.

In some embodiments, the gate comprises a head and a pin, and the first fluid circuit comprises a bore in which the pin is received. The pin slides in the bore based on the return spring pressure and the balance of fluid pressures in the first fluid circuit and the second fluid circuit. If the fluid pressure in one of the circuits changes sufficiently, the pin slides in one direction or the other to open or close the valve with the aid of the spring pressing on the head.

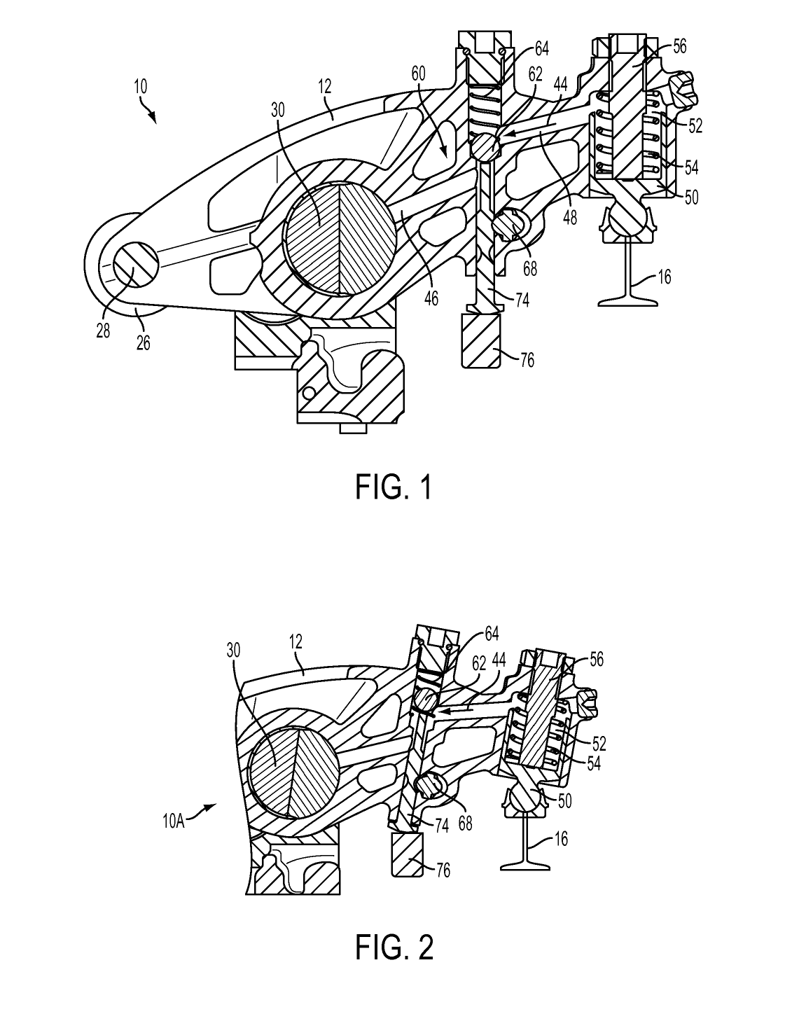

Operation of the braking system described above and further below provides several advantages over prior art mechanical reset braking systems. An exemplary prior art compression braking system 10 will now be described in more detail with reference to FIG. 1 for reference. System 10 comprises a rocker lever 12 that operates to reciprocally displace one or more exhaust valves 16, during a brake mode of operation, into the engine cylinder near the end of the compression stroke of the engine piston, to exhaust the compressed gas from the cylinder. The exhaust valve is closed prior to the end of the expansion stroke and before the hydraulic pressure drops due to a return motion of the master piston. A three-way solenoid valve controls the flow of fluid to the brake system and thus the beginning and end of the brake mode. System 10 also includes a cam (not shown) configured to pivot rocker lever 12. A cam roller 26, mounted on one end of rocker lever 12 via a roller pin 28, is positioned in biased abutment against the cam's surface. The cam may include four portions which define four operational phases of the system: an inner base portion, a brake lift portion, a dwell portion and a main lift portion. As the cam rotates, rocker lever 12 is pivoted around support shaft 30 to operate in any one of the four phases.

A rocker lever fluid circuit includes a low pressure circuit 46, a high pressure circuit 48 and an slave piston bore 52 slidably receiving a slave piston 50. A reset valve 60 is positioned between low pressure circuit 46 and high pressure circuit 48 to control the flow of fluid therebetween and thus control the movement of slave piston 50 and exhaust valve 16. A return spring 54, positioned in slave piston bore 52, biases slave piston 50 outwardly toward exhaust valve 16. Low pressure circuit 46 may include passages (not shown) formed in support shaft 30 fluidly selectively coupled with reset valve 60. A reset pin 74 is slidably mounted in a bore formed on the low pressure circuit side of valve 60 adjacent the valve seat for abutment by valve head 62. Thus, reset pin 74 is positioned to contact and move valve head 62 against the force of bias spring 64. During the brake mode, the control valve couples low pressure circuit 46 to a fluid supply line (not shown) to enable fluid supply to high pressure circuit 48. During the power mode, the control valve disables high pressure circuit 48 and exhaust valve 16. Pivoting movement of rocker lever 12 causes reset pin 74 to contact reset pedestal 76 causing reset pin 74 to move upwardly, thereby moving valve head 62 off its seat from a closed position into an open position, as shown in FIG. 2, releasing pressure on high pressure circuit 48. A détente 68 engages a slot on reset pin 74 to prevent pressure build-up until the next brake cycle. An exemplary prior art braking system is disclosed in U.S. Pat. No. 6,253,730, which is incorporated by reference herein in its entirety. U.S. Provisional Patent Application Ser. No. 61/730,395, filed Nov. 27, 2012, is also incorporated by reference herein in its entirety.

The embodiments of the present invention, described above and further below, advantageously increase the reliability of the prior art compression braking systems by operating with fewer components, reduced mechanical activity and more accurate control of the exhaust valve seating velocity.

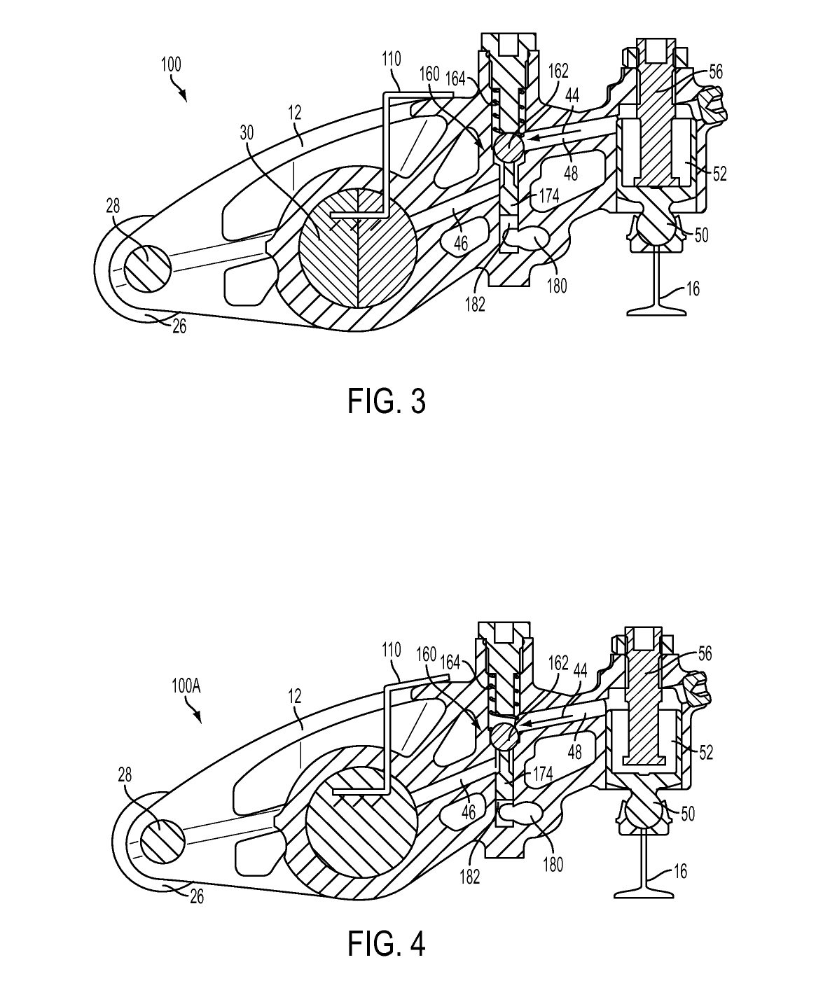

Referring to FIGS. 3 and 4, there is shown an exemplary embodiment of a compression braking system according to the invention, indicated generally by numeral 100. The cross-sectional view depicted in FIG. 3 shows the system in the brake mode, and the cross-sectional view depicted in FIG. 4 shows the system in the power mode. System 100 comprises rocker lever 12 that operates to reciprocally displace one or more exhaust valves 16, during a brake mode of operation, to exhaust the compressed gas from the cylinder. Braking system 100 further comprises a control system including an engine control module (not shown) and a control valve (not shown) that controls the flow of fluid through the system. Suitable control modules and control valves are well known. System 100 comprises rocker lever 12 supporting cam follower 26 and slave piston 50. Rocker lever 12 also comprises a first fluid circuit, a second fluid circuit 44, a rocker lever valve 160 along second fluid circuit 44 and slave piston 50 slidably received in slave piston bore 52 and connected to exhaust valve 16. A biasing member 110 is mounted on a stationary element (not shown) of the internal combustion engine and applying a biasing force to rocker lever 12 to pivot rocker lever 12 and prevent contact between cam follower 26 and the brake lift portion of the cam, to prevent the brake events. Application of a brake mode fluid pressure to a fluid in second fluid circuit 44 extends slave piston 50 to an extended position, which at least partially collapses biasing member 110 and permits contact between cam follower 26 and the brake lift portion of the cam, to activate brake events as the cam rotates. Thus, the cam is enabled and controls exhaust valve 16 and the main exhaust valves during braking and main exhaust events. In the present embodiment, a slave piston return spring is not present. In a variation thereof, a return spring may be provided assist with extension of slave piston 50 or to stabilize slave piston 50.

Rocker lever valve 160 is positioned between low pressure circuit 46 and high pressure circuit 48 and includes a gate, a valve seat, and a return spring 164 applying pressure against the gate. An exemplary gate includes a head 162 and a pin 174. Pin 174 is slidably received in a bore 182. The first fluid circuit, illustratively shown as fluid reservoir 180 and bore 182, is pressurized to bias the gate inwards and thus to open rocker lever valve 160. Return spring 164 has a potential energy, when compressed, sufficient to close rocker lever valve 160 when the first fluid pressure (the pressure in the first fluid circuit) and the brake mode fluid pressure are equal. In one example, the first fluid pressure is an overhead oil pressure of the internal combustion engine. The overhead oil pressure will typically range between 34 and 40 PSI. In a variation of the present embodiment, the potential energy is sufficient to overcome a difference between the first fluid pressure and the brake mode fluid pressure, to close the rocker lever valve, but not so high that it closes the rocker lever valve in the power mode, when pressure in the low pressure circuit may be positive yet substantially less than the overhead pressure.

Low pressure circuit 46 may include passages (not shown) formed in support shaft 30 fluidly selectively coupled with the control valve. The control valve may comprise a three-way solenoid valve which functions to selectively control the beginning and the end of the brake mode. During the power mode, the control valve disables high pressure circuit 48 and exhaust valve 16. During the brake mode, the control valve couples low pressure circuit 46 to a braking fluid supply line (not shown) to pressurize high pressure circuit 48.

In the power mode, or brake-off position of system 100, second fluid circuit 44 is full and may be maintained at a low, negligible or zero pressure. A fluid pressure sufficient to cause pin 174 to unseat valve head 162 is applied to maintain valve head 162 in the unseated position throughout the cycle. A biasing member 110 applies biasing pressure against rocker lever 12 to hold cam follower 26 away from the cam during lost motion lifts. An exemplary biasing member 110 comprises a leaf spring. Biasing member 110 may be attached to rocker shaft 30, for example by a rocker shaft capscrew. Lash may be controlled in any manner known in the art. Advantageously, slave piston 50 does not travel in the power mode. The reliability of system 110 is further enhanced because fluid flow in second fluid circuit 44 is not required, except to add make-up fluid. A further advantage is that by maintaining some pressure in second fluid circuit 44 during non-braking, the engine braking mechanism can be engaged quickly.

A further advantage is that there is no need for the cam to include reset over-travel, so it is possible to increase the base radius of the cam relative to the base radius of a cam that includes reset over-travel, increasing robustness and reliability of the braking system. An additional benefit is enhanced safety. Because the rocker lever cam follower is separated from the cam during non-braking, high speed brake events are prevented from occurring. The reliability of system 100 is further enhanced by the reduced component count. For instance, biasing member 110 replaces a slave piston spring and a detent plunger assembly required to maintain the reset pin in position (see FIGS. 1 and 2). Further, because the cam controls the seating velocity of the exhaust valves during all events, consistent performance over time is achieved. The cam can be matched to the engine design and selected seating velocity and can be expected to deliver such seating velocities.

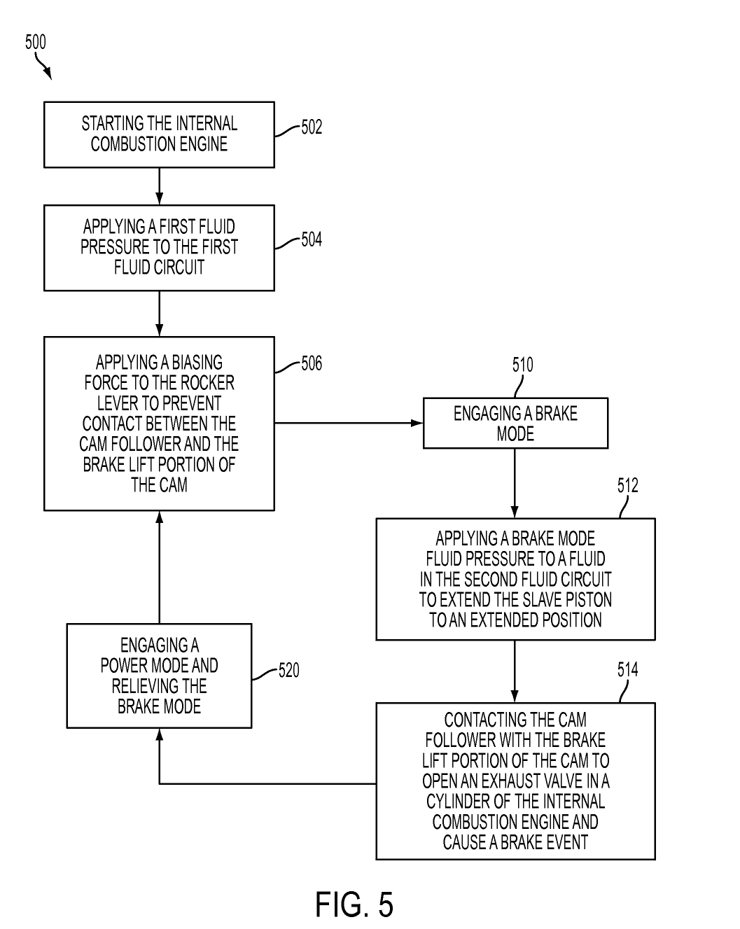

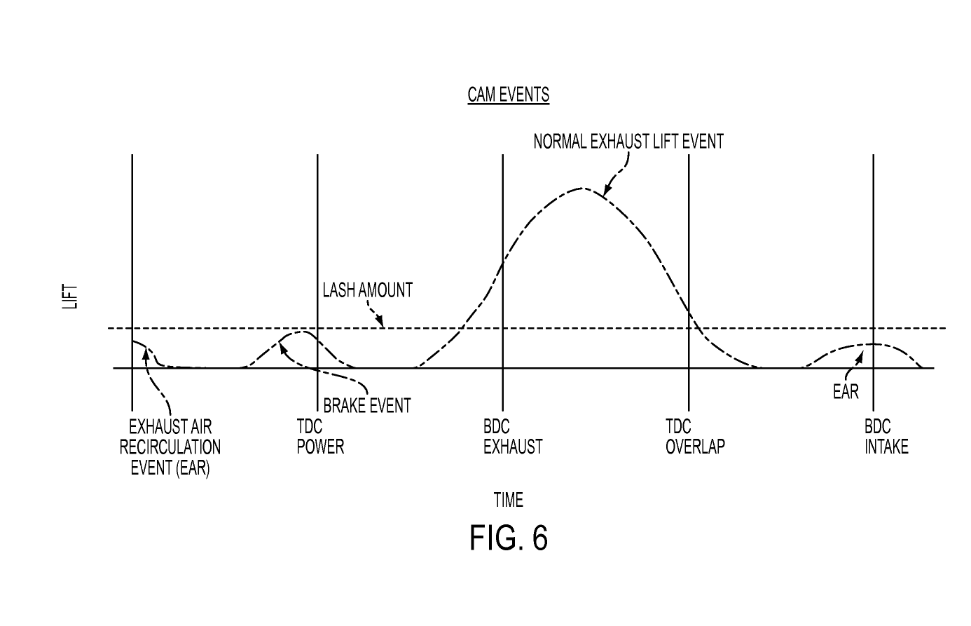

An embodiment of the method of operating a compression braking system will now be described with reference to a flowchart 500 in FIG. 5 and the graph depicted in FIG. 6. The method is implemented by an internal combustion engine including a cylinder, a cam having a brake lift portion, and a pivotally mounted rocker lever supporting a cam follower and a slave piston, the rocker lever including a first fluid circuit, a second fluid circuit and a rocker lever valve along the second fluid circuit. The method begins at 502, starting the internal combustion engine. The method continues, at 504, applying a first fluid pressure to the first fluid circuit. The first fluid pressure is greater than the residual potential energy of return spring 164, which is extended when rocker lever valve 160 is closed. Therefore, application of the first fluid pressure opens rocker lever valve 160.

The method continues at 506, applying a biasing force to the rocker lever to prevent contact between the cam follower and the brake lift portion of the cam. The biasing force is applied by a biasing member. An exemplary biasing member is biasing member 110. While contact is prevented, the braking system is in the power mode of operation. An operator can then engage a brake mode, at 510. For example, the operator may engage a contact, for example by turning a switch “on”. Upon engagement of the contact, a control system, such as an engine control unit of the engine, activates a fluid supply, such as a fluid reservoir pump. Thereafter, while in the brake mode, the method continues at 512, applying a brake mode fluid pressure to a fluid in the second fluid circuit to extend the slave piston to an extended position. The brake mode fluid pressure may be applied by the fluid reservoir pump to pressurize second circuit 44, for example. As discussed previously, changing a balance of fluid pressures on the rocker lever valve actuates the rocker lever valve. Increasing pressure in the low pressure circuit sufficiently to exceed the pressure difference between the first circuit fluid pressure and the return spring pressure causes the rocker lever valve to close. Decreasing pressure in the low pressure circuit below the pressure difference between the first circuit fluid pressure and the return spring pressure causes the rocker lever valve to open. Thus, if the brake mode fluid pressure equals the first circuit fluid pressure, the return spring pressure causes the valve to close. In one variation, the pressure is reduced on the low pressure circuit to a fluid retaining pressure which is sufficiently high to retain the fluid in the low pressure circuit. The retaining pressure is positive pressure greater than 0 PSI. The retaining pressure may be, for example, between 0.1 and 10 PSI.

The method continues at 514, contacting the cam follower with the brake lift portion of the cam to open an exhaust valve in a cylinder of the internal combustion engine and cause a brake event. Contacting results from extension of slave piston 50 by the application of the brake mode fluid pressure to second circuit 44.

The method continues at 520, engaging a power mode and relieving the brake mode. Engaging the power mode and relieving the brake mode may be achieved by turning the switch “off”. In the power mode, slave piston 50 does no longer collapses biasing member 110, therefore cam follower 28 does not contact the brake lift portion of the cam.

As used herein, the transitional term “comprising”, which is synonymous with “including,” or “containing,” is inclusive or open-ended and does not exclude additional, unspecified elements or method steps. By contrast, the transitional term “consisting” is a closed term which does not permit addition of unspecified terms.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

We claim:

1. A method of braking using an internal combustion engine, the method comprising:
starting the internal combustion engine, the internal combustion engine including a cylinder, a cam having a brake lift portion, and a pivotally mounted rocker lever supporting a cam follower and a slave piston, the rocker lever including a first fluid circuit, a second fluid circuit and a rocker lever valve along the second fluid circuit;
applying a first fluid pressure to the first fluid circuit to open the rocker lever valve;
applying a biasing force to the rocker lever to prevent contact between the cam follower and the brake lift portion of the cam;
engaging a brake mode, and while in the brake mode:
applying a brake mode fluid pressure to a fluid in the second fluid circuit to extend the slave piston to an extended position; and
contacting the cam follower with the brake lift portion of the cam to open an exhaust valve in the cylinder of the internal combustion engine and cause a brake event.

2. A method as in claim 1, the internal combustion engine further comprising a biasing member connected to a supporting element of the internal combustion engine and applying the biasing force to the rocker lever, wherein extension the slave piston collapses the biasing member to enable the cam follower to engage a base portion of the cam.

3. A method as in claim 1, further comprising changing a balance of fluid pressures on the rocker lever valve to actuate the rocker lever valve.

4. A method as in claim 3, wherein the second fluid circuit includes a low pressure circuit fluidly coupling a rocker lever shaft, on which the rocker lever is pivotally mounted, with the rocker lever valve, and a high pressure circuit fluidly coupling the rocker lever valve with the slave piston, the method further comprising relieving the brake mode fluid pressure from the low pressure circuit to close the rocker lever valve.

5. A method as in claim 4, wherein relieving the brake mode fluid pressure from the low pressure circuit comprises reducing fluid pressure on the low pressure circuit to a fluid retaining pressure which is sufficiently high to retain the fluid in the low pressure circuit.

6. A method as in claim 5, wherein the fluid retaining pressure is between 0.1 and 10 pounds per square inch (PSI).

7. A method as in claim 3, the rocker lever valve including a gate, a valve seat, and a return spring applying pressure against the gate opposite the first fluid pressure.

8. A method as in claim 7, wherein the first fluid pressure is an overhead oil pressure of the internal combustion engine.

9. A method as in claim 7, wherein the first fluid pressure and the brake mode fluid pressure are equal.

10. A method as in any one of claims 1-9, the method further comprising controlling a seating velocity of the exhaust valve with a contoured portion of the cam, the contour of the contoured portion proportional to the seating velocity.

11. An internal combustion engine operable in a brake mode, the internal combustion engine comprising:
a cylinder;
an exhaust valve operable to exhaust combusted gases from the cylinder to cause brake events;
a rocker lever pivotally mounted on a rocker lever shaft;
a cam including a brake lift portion;
a cam follower mounted on the rocker lever;
a slave piston mounted on the rocker lever and connected to the exhaust valve;
a first fluid circuit formed in the rocker lever;
a biasing member mounted on a stationary element of the internal combustion engine and applying a biasing force to the rocker lever to pivot the rocker lever and prevent contact between the cam follower and the brake lift portion of the cam, to prevent the brake events;
a second fluid circuit formed in the rocker lever and fluidly coupled with the slave piston; and
a rocker lever valve along the second fluid circuit, wherein application of a brake mode fluid pressure to a fluid in the second fluid circuit extends the slave piston to an extended position, which at least partially collapses the biasing member and permits contact between the cam follower and the brake lift portion of the cam, to activate brake events as the cam rotates.

12. An internal combustion engine as in claim 11, wherein the second fluid circuit includes a low pressure circuit fluidly coupling the rocker lever shaft with the rocker lever valve, and a high pressure circuit fluidly coupling the rocker lever valve with the slave piston, wherein relieving the brake mode fluid pressure from the low pressure circuit closes the rocker lever valve.

13. An internal combustion engine as in claim 11, the rocker lever valve including a gate, a valve seat, and a return spring applying pressure against the gate opposite the first fluid pressure.

14. An internal combustion engine as in claim 13, wherein the return spring has a potential energy, when compressed, sufficient to close the rocker lever valve when the first fluid pressure and the brake mode fluid pressure are equal.

15. An internal combustion engine as in claim 14, wherein the first fluid pressure is an overhead oil pressure of the internal combustion engine.

16. An internal combustion engine as in any one of claims 11-15, wherein the brake lift section is contoured proportionally to a predetermined seating velocity of the exhaust valve.

17. An internal combustion engine as in claim 16, wherein the gate comprises a head and a pin, and the first fluid circuit comprises a bore in which the pin is received.

18. An internal combustion engine as in claim 17, wherein the biasing member comprises a leaf spring.

19. An internal combustion engine as in claim 18, wherein the biasing member is affixed to the rocker lever shaft.

20. A braking system for an internal combustion engine comprising an exhaust valve operable to exhaust combusted gases from a cylinder to cause brake events, the braking system comprising:
a rocker lever pivotally mounted on a rocker lever shaft;
a cam including a brake lift portion;
a cam follower mounted on the rocker lever;
a slave piston mounted on the rocker lever and connected to the exhaust valve;
a first fluid circuit formed in the rocker lever;
a biasing member mounted on a stationary element of the internal combustion engine and applying a biasing force to the rocker lever to pivot the rocker lever and prevent contact between the cam follower and the brake lift portion of the cam, to prevent the brake events;
a second fluid circuit formed in the rocker lever and fluidly coupled with the slave piston; and
a rocker lever valve along the second fluid circuit, wherein application of a brake mode fluid pressure to a fluid in the second fluid circuit extends the slave piston to an extended position, which at least partially collapses the biasing member and permits contact between the cam follower and the brake lift portion of the cam, to activate brake events as the cam rotates.

21. A braking system as in claim 20, wherein the second fluid circuit includes a low pressure circuit fluidly coupling the rocker lever shaft with the rocker lever valve, and a high pressure circuit fluidly coupling the rocker lever valve with the slave piston, wherein relieving the brake mode fluid pressure from the low pressure circuit closes the rocker lever valve.

22. A braking system as in claim 21, further comprising a fluid supply source and a fluid supply circuit in the rocker lever shaft coupling the fluid supply source with the second circuit to pressurize the second circuit and prevent oil flow in the second circuit.

23. A braking system as in claim 20, the rocker lever valve including a gate, a valve seat, and a return spring applying pressure against the gate opposite the first fluid pressure.

24. A braking system as in claim 23, wherein the return spring has a potential energy, when compressed, sufficient to close the rocker lever valve when the first fluid pressure and the brake mode fluid pressure are equal.

25. A braking system as in claim 24, wherein the first fluid pressure is an overhead oil pressure of the internal combustion engine.

26. A braking system as in any one of claims 20-25, wherein the brake lift section is contoured proportionally to a predetermined seating velocity of the exhaust valve.

27. A braking system as in claim 26, wherein the brake lift section is dimensioned to extend the slave piston to the extended position without a reset over-travel.

28. A braking system as in claim 26, wherein the gate comprises a head and a pin, and the first fluid circuit comprises a bore in which the pin is received.

29. A braking system as in claim 26, wherein the biasing member comprises a leaf spring.

30. A braking system as in claim 26, wherein the biasing member is affixed to the rocker lever shaft.

31. A braking system as in claim 26, wherein the rocker lever includes a slave piston bore, and the slave piston is slidably received in the slave piston bore without a slave piston spring.
